(19) United States
(12) Patent Application Publication
(10) Pub. No.: US 2025/0347825 A1
(43) Pub. Date: Nov. 13, 2025

(54) METASTRUCTURES INCLUDING META-ATOMS HAVING OUTWARDLY SLOPING SIDEWALLS

(71) Applicant: NIL Technology ApS, Kongens Lyngby (DK)

(72) Inventors: Jesper Fly Hansen, Copenhagen (DK); Maksim Zalkovskij, Copenhagen (DK); Lars Hagedorn Frandsen, Tårnby (DK); Brian Bilenberg, Ølstykke (DK)

(21) Appl. No.: 18/868,320

(22) PCT Filed: May 24, 2023
(86) PCT No.: PCT/EP2023/063939

§ 371 Date: Nov. 22, 2024

Related U.S. Application Data
(60) Provisional application No. 63/347,401, filed on May 31, 2022.

(51) Int. Cl. G02B 1/00; G02B 5/18

(52) U.S. Cl. CPC G02B 1/002; G02B 5/1857; G02B 2207/101

(57) ABSTRACT

The present disclosure describes metastructure optical elements (MOEs), methods for manufacturing the MOEs, and devices incorporating the MOEs. The MOEs include meta-atoms that have outwardly sloping sidewalls. A meta-atom can have sidewalls that are substantially vertical along an upper section of the meta-atoms, and that slope outwardly along a lower section of the meta-atom.

### FIELD OF THE DISCLOSURE

The present disclosure relates to metastructure optical elements (MOEs).

### BACKGROUND

Advanced optical elements may include a metasurface, which refers to a surface with distributed small structures (e.g., meta-atoms) arranged to interact with light in a particular manner. For example, a metasurface, which also may be referred to as a metastructure, can be a surface with a distributed array of nanostructures. The nanostructures may, individually or collectively, interact with light waves. For example, the nanostructures or other meta-atoms may change a local amplitude, a local phase, or both, of an incoming light wave.

MOEs can include multiple meta-atoms. The manufacture of MOEs sometimes involves etching the meta-atoms into a stratum. In some cases, the meta-atoms occur in different groupings within the MOE, and the different groupings of meta-atoms may have different etch characteristics. MOEs configured with two or more groupings having different etch characteristics may be particularly difficult to manufacture using known etching methods.

### SUMMARY

The present disclosure describes MOEs, methods for manufacturing the MOEs, and devices incorporating the MOEs. The MOEs include meta-atoms that have outwardly sloping sidewalls. In particular, a meta-atom can have sidewalls that are substantially vertical along an upper section of the meta-atoms, and that slope outwardly along a lower section of the meta-atom (i.e., the section of the meta-atom closer to the surface of a substrate that supports the meta-atoms).

For example, in one aspect, the present disclosure describes an apparatus that includes a substrate supporting a plurality of meta-atoms each of which has at least one respective outer sidewall. An upper portion of the at least one sidewall of each of the meta-atoms is perpendicular to a surface of the substrate supporting the meta-atoms. A lower portion of the at least one sidewall of each of the meta-atoms slopes outwardly, wherein the lower portion is adjacent an interface between the meta-atom and the surface of the substrate.

Some implementations include one or more of the following features. For example, in some cases, the lower portion of the at least one sidewall of each of the meta-atoms slants outwardly or curves outwardly. In some instances, the lower portion of the at least one sidewall of each of the meta-atoms is concave-shaped. A diameter of each respective one of the meta-atoms at the lower portion can be greater than a diameter of the meta-atom at the upper portion of the meta-atom. In some implementations, the lower portion of the at least one sidewall of each one of the meta-atoms extends less than fifty percent of the height of the meta-atom, and in some cases, no more than five percent of the height of the meta-atom.

In some implementations, the plurality of meta-atoms includes a first grouping of meta-atoms whose respective upper portions have a first diameter and a second grouping of meta-atoms whose respective upper portions have a second diameter that differs from the first diameter. In some implementations, the plurality of meta-atoms includes a first grouping of meta-atoms arranged in a first density and a second grouping of meta-atoms arranged in a second density that differs from the first density.

In some implementations, the substrate is composed of glass or fused silica, and/or the meta-atoms are composed of silicon, titanium oxide, zinc oxide, aluminum zinc oxide, or a niobium oxide.

The present disclosure also describes a method including providing a structure that includes a layer of a stratum material on a substrate, wherein the structure further includes a mask on the stratum material, the mask defining areas of the stratum material where meta-atoms are to be formed, each of the respective meta-atoms having at least one sidewall. The method further includes performing an etch process that includes a first etch stage and a second etch stage. The first etch stage removes portions of the stratum material such that trenches are etched into the stratum material to form an upper section of the at least one sidewall of each of the meta-atoms, the upper section being perpendicular to a surface of the substrate. The second etch stage removes further portions of the stratum material to form a lower portion of the at least one sidewall of each of the meta-atoms, the lower portion being adjacent an interface between the meta-atom and the surface of the substrate and sloping outwardly.

Some implementations include one or more of the following features. For example, in some cases, each of the first and second etch stages is part of a plasma etch process. In some cases, the first etch stage includes a plasma etch having an average flow of a passivation gas and an average flow of an etchant gas, and the second etch stage includes a plasma etch in which at least one of an average flow of the passivation gas or an average flow of the etchant gas differs from the first etch stage. For example, in some cases, in the second etch stage, the average flow of the passivation gas is greater than the average flow of the passivation gas during the first etch stage. In some cases, in the second etch stage, the average flow of the etchant gas is less than the average flow of the etchant gas during the first etch stage. In some instances, at least one of a plasma power or a bias toward the substrate during the second etch stage is less than during the first etch stage.

In some implementations, the first etch stage includes a plasma etch and the second stage includes an isotropic etch.

In some implementations, the method further includes removing the mask.

In some implementations, the outwardly sloping sidewalls can help improve the mechanical stability of some or all of the meta-atoms.

Other aspects, features and advantages will be readily apparent form the following detailed description, the accompanying drawings, and the claims.

### BRIEF DESCRIPTION OF THE DRAWINGS

FIG. 1A-FIG. 1D depict example process steps for manufacturing MOEs.

FIG. 2 is a cross-sectional view of an example metastructure in accordance with the present disclosure.

FIG. 3 is a cross-sectional view of another example meta-atom in accordance with the present disclosure.

FIG. 4 is a flow chart illustrating an etching process for forming meta-atoms in accordance with the present disclosure.

FIG. 5 is a flow chart illustrating a plasma etch process for forming meta-atoms in accordance with the present disclosure.

FIGS. 6A-FIG. 6D are cross-sectional views of various stages in a method of manufacturing a metastructure in accordance with the present disclosure.

FIG. 7 is a flow chart illustrating another example process for forming meta-atoms in accordance with the present disclosure.

### DETAILED DESCRIPTION

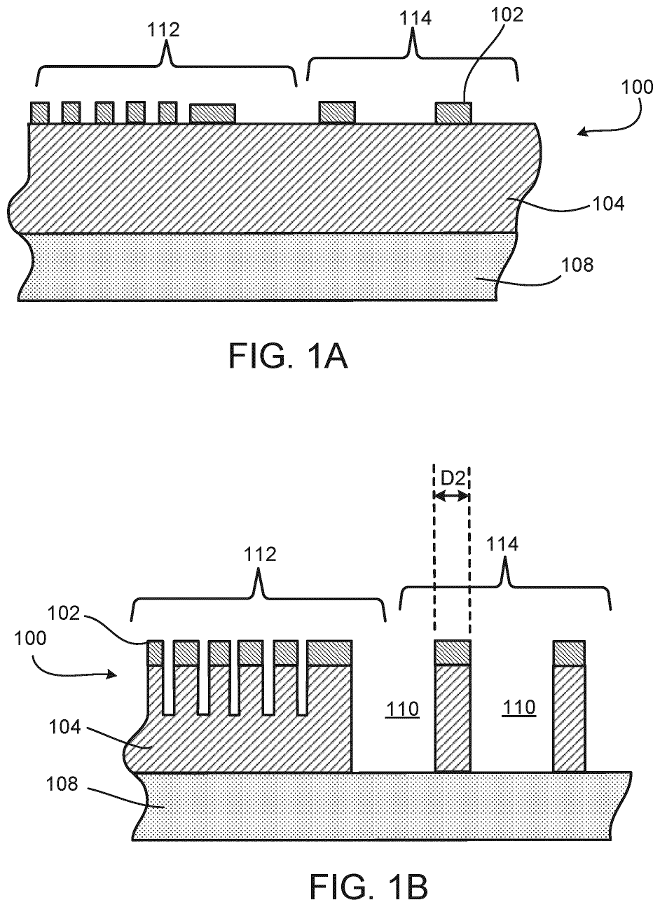

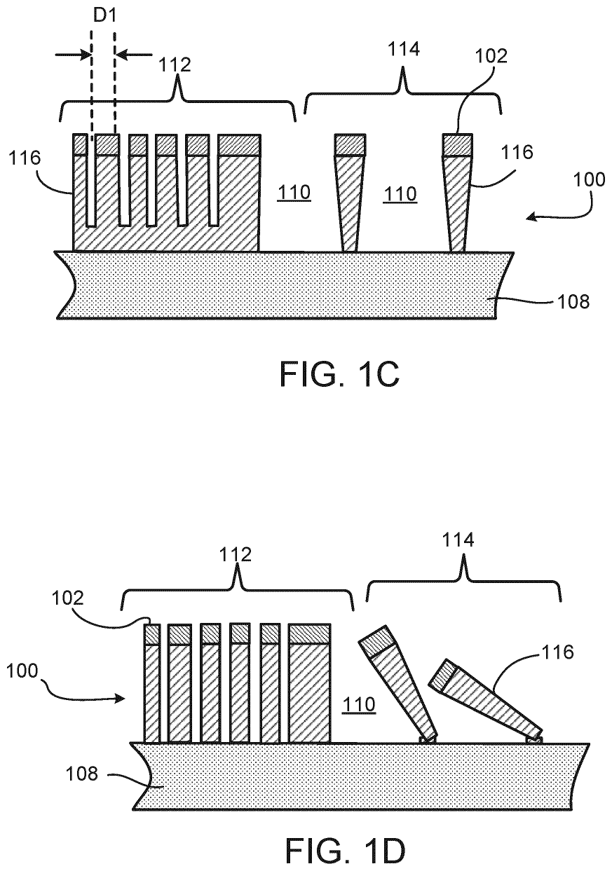

FIG. 1A-FIG. 1D depict examples of several stages of a manufacturing process of one or more metastructure optical elements (MOEs). A metastructure optical assembly, as depicted in FIG. 1A-FIG. 1D, can be an intermediary product created during the manufacture of one or more MOEs. The metastructure optical assembly 100 includes a mask 102 disposed on a stratum 104. The stratum 104, in turn, is disposed on a substrate 108. The metastructure optical assembly 100 can take the form, for example, of a wafer having a large lateral dimension with many MOEs.

With the mask 102 in place, the stratum 104 can be etched to form the meta-atoms 116 separated by regions 110 where the stratum material has been removed as a result of the etching. A given MOE may include two or more groupings 112, 114 of meta-atoms 116, which may exhibit different etch characteristics from one another as a result, for example, of their different densities. That is, even if the meta-atoms 116 in each of the groupings 112, 114 have the same pitch, the diameters of the meta-atoms in the groupings may differ from one another. For example, meta-atoms 116 in the first group 112 may have a diameter D1 that differs from (e.g., is larger than) the diameter D2 of meta-atoms 116 in the second group 114 (see FIGS. 1B and 1C). As a result of the different diameters, and thus the different densities, the first group 112 of meta-atoms may have a first etch characteristic and the second group 114 of meta-atoms may have a different second etch characteristic 114.

Further, as depicted in FIG. 1D, as a result of the different etch characteristics, some of the meta-atoms 116 within at least one of the groups (e.g., group 114) may fail, fracture, or otherwise be destroyed during the etching process since the etch rate is different between the two groupings 112 and 114. For example, meta-atoms 116 in the second group 114 having relatively smaller diameters (D2) and/or lower density are subject to a greater risk of being damaged due to power reflected by the substrate during the etch process. The reflected power may cause, for example, the bottom of the meta-atoms in the second group 114 to be undercut slightly, thereby resulting in the meta-atoms being physically unstable, as illustrated in FIG. 1D.

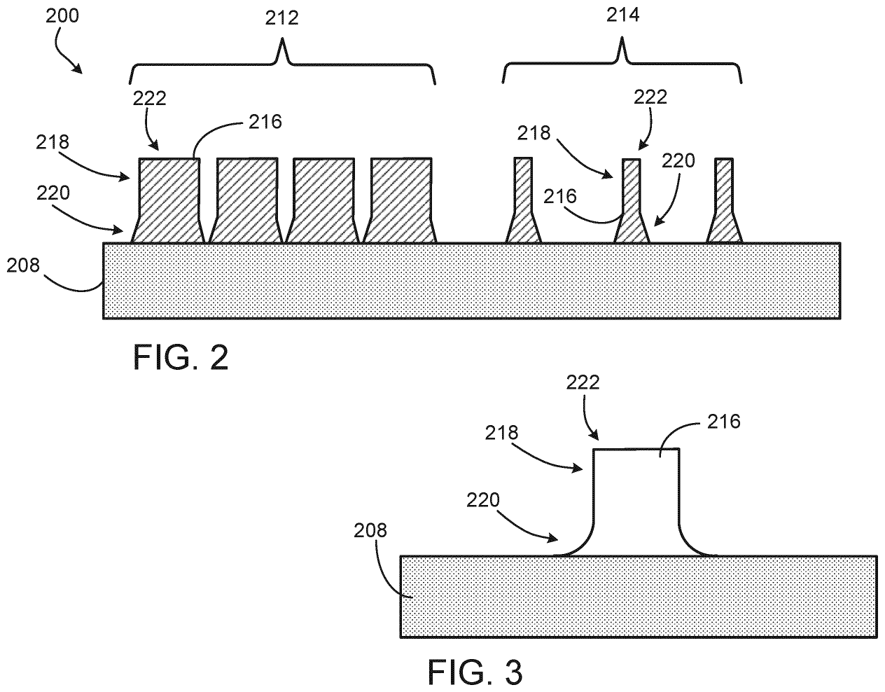

To reduce the likelihood that the meta-atoms will be physically unstable, the portion of the meta-atoms sides closer to the substrate can be made to slope outward slightly. That is, as shown in the MOE 200 of FIG. 2, although the upper portion 218 of each meta-atom 216 has substantially vertical walls (i.e., sidewalls that are substantially perpendicular to the surface of the substrate 208), the sidewalls along the lower portion 220 of each meta-atom 216 (i.e., closer to the substrate 208) slope outwardly. For example, in some instances, the sidewalls along the lower portion 220 may taper (e.g., slant) away from the vertical sidewalls such that the diameter of the meta-atom 216 at the interface with the substrate 208 is greater than the diameter of the meta-atom at its upper (free) end 222. In some instances, as shown in FIG. 3, the sidewalls along the lower portion 220 of the meta-atom 216 may be curved (e.g., concave shaped).

In an example implementation, the upper portion of each meta-atom having substantially vertical sidewalls may represent at least fifty percent of the height of the meta-atom. Thus, the outwardly sloping portion of the sidewalls at the lower portion of the meta-atom generally will extend up to less than fifty percent the height of the meta-atom. In some instances, the outwardly sloping portion of the sidewalls extends no more than twenty-five percent of the height of the meta-atom, and in some cases, no more than five percent of the height of the meta-atom. Thus, for meta-atoms having a height of about 500 nm, the outwardly sloping portion of the sidewalls might have a height of less than 250 nm, and in some cases, no more than 125 nm or possibly no more than 25 nm.

The MOE 200 can include just a few meta-atoms, or tens, hundreds, thousands, millions, or even hundreds of millions of meta-atoms, depending on the application. The MOE 200 may include two or more groupings of meta-atoms having, for example, a different respective diameter or a different respective density of meta-atoms. Thus, in some cases, the sum of the areas (e.g., determined via the meta-atom diameters) of the individual meta-atoms 216 within a particular group 212 divided by the area of the MOE the particular grouping occupies may be different than that of another grouping 214 of meta-atoms 216.

In some instances, meta-atoms 216 in one or more of the groups 212, 214 have outwardly sloping sidewalls as described above. In some instances, only a subset of the meta-atoms of a particular MOE may have outwardly sloping sidewalls. For example, in some cases, meta-atoms having a relatively smaller diameter and/or lower density (e.g., group 214) may have outwardly sloping sidewalls as described above, whereas meta-atoms having a relatively larger diameter and/or higher density (e.g., group 212) may have substantially vertical sidewalls that extend from the top (free) end 222 of the meta-atom to the bottom end that contacts the substrate 208. In other cases, meta-atoms having a relatively larger diameter and/or higher density (e.g., group 212) may have outwardly sloping sidewalls as described above, whereas meta-atoms having a relatively smaller diameter and/or lower density (e.g., group 214) may have substantially vertical sidewalls that extend from the top (free) end 222 of the meta-atom to the bottom end that contacts the substrate 108.

The substrate 208 can be composed, for example, of glass or fused silica. The meta-atoms 216 can be composed, for example, of silicon (e.g., polysilicon, amorphous silicon, crystalline silicon, or silicon nitride), titanium oxide, zinc oxide, aluminum zinc oxide, or a niobium oxide. The meta-atoms 216 may have, for example, a circular, square, or doughnut-shaped cross-section. Other materials and shapes for the meta-atoms 216 or substrate 208 may be used in some implementations.

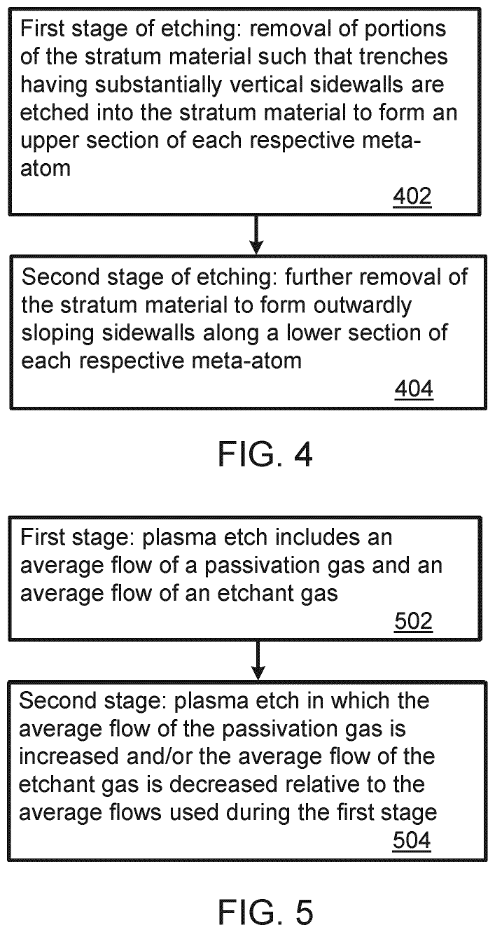

MOEs having sidewalls that are substantially vertical along the upper portion (i.e., near their free end) and that slope outwardly along the lower portion (i.e., adjacent the interface with the substrate) can be fabricated in various ways. In general, as indicated by FIG. 4, a first stage of etching (402) results in removal of portions of the stratum material such that trenches having substantially vertical sidewalls are etched into the stratum material to form an upper section of each respective meta-atom, and a second stage of etching (404) results in further removal of the stratum material to form outwardly sloping sidewalls along a lower section of each respective meta-atom (i.e., the section of the meta-atom closer to the surface of a substrate that supports the meta-atoms).

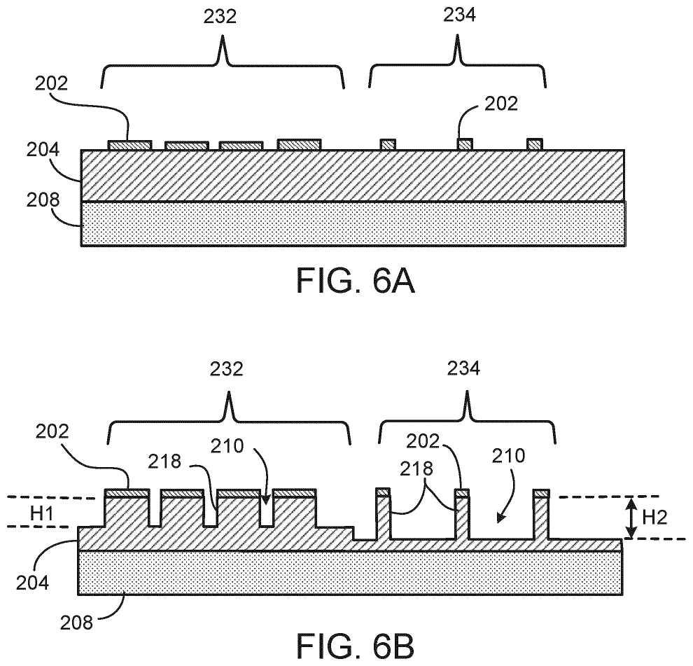

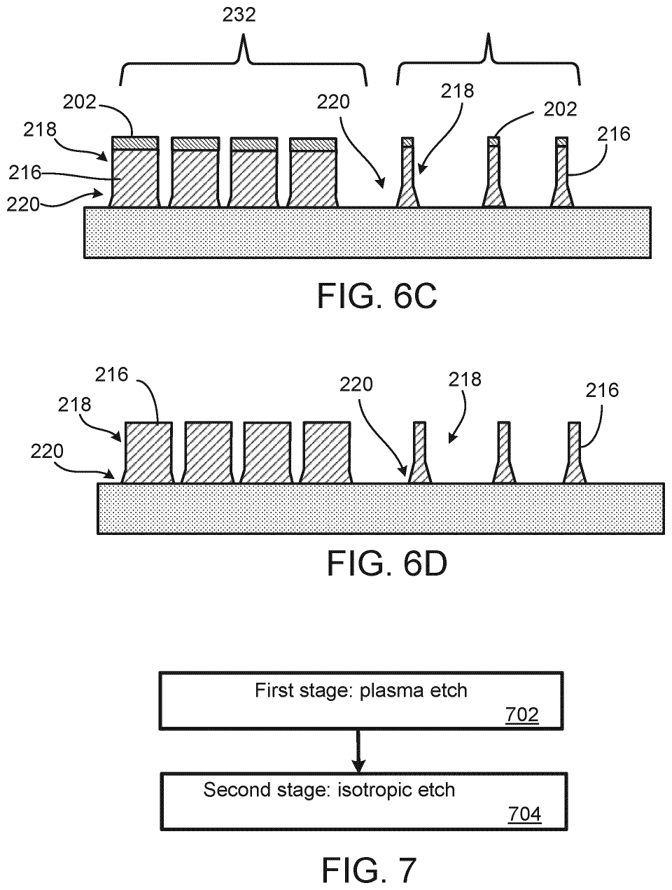

In accordance with some implementations, the meta-atoms are formed using an etch process (e.g., a plasma etch) that includes a passivation gas and an etchant gas. The etch process is divided into at least two stages, wherein the ratio of the average flow of the passivation gas to the average flow of the etchant gas for one stage differs from the ratio during another stage. For example, as indicated by FIG. 5, in a first stage (502), the plasma etch can include an average flow of a passivation gas and an average flow of an etchant gas. During a subsequent, second stage (504), the average flow of the passivation gas can be increased and/or the average flow of the etchant gas can be decreased relative to the average flows used during the first stage. An example process is described below in connection with FIGS. 6A-6C.

FIG. 6A shows an example of a structure that includes a mask 202 disposed on a stratum 204 of material from which the meta-atoms are formed. The stratum 204 may be composed, for example, of polysilicon, amorphous silicon, crystalline silicon, titanium oxide, silicon nitride, zinc oxide, aluminum zinc oxide, or a niobium oxide. The mask 202 can be, for example, an organic (e.g., amorphous carbon) or inorganic (e.g., SiN, SiON, TiN) hardmask. In some instances, the mask 202 may be composed of metal, such as chrome, aluminum or titanium. The stratum 204 is disposed on a substrate 208 (e.g., glass or fused silica) and may be deposited onto the substrate 208, for example, by chemical vapor deposition. In some instances, the substrate 208 takes the form of a wafer having a large lateral dimension on which many MOEs can be formed. For example, some wafers may have a radius from 1 inch to more than 20 inches and a thickness of only a few hundred microns, though wafers having other dimensions are within the scope of this disclosure. The mask 202 may be deposited on the stratum 204, for example, by sputtering or chemical vapor deposition.

In the illustrated example, the locations of the mask 202 on the stratum 204 correspond to the locations of the meta-atoms to be formed on the substrate 208. In this example, a first portion 232 of the mask material corresponds to the locations for a first group of meta-atoms each of which has a first, relatively large, diameter, and where the first group of meta-atoms are present in a first, relatively high density. A second portion 234 of the mask material corresponds to the locations for a second group of meta-atoms each of which has a second, relatively small, diameter, and where the second group of meta-atoms are present in a first, relatively low density.

During subsequent stages of processing, the stratum 204 is etched so as to form the meta-atoms. In the illustrated example, the stratum 204 is etched using a plasma etch that includes a passivation gas and an etchant gas. During a first stage of the plasma etch, the ratio of the passivation gas to the etchant gas can be expressed as P:E, whereas during a subsequent, second stage, the ratio is changed either by increasing the amount of passivation gas (i.e., a ratio of P+x:E), reducing the amount of the etchant gas (i.e., a ratio of P:E-y), or both (i.e., a ratio of P+x:E-y).

The ratio (P:E) of the gases for the first stage can be chosen so that trenches 210 having substantially vertical sidewalls 218 are etched into the stratum 204, as shown in FIG. 6B. Due to the different diameters of the meta-atoms being formed for each group (and the different densities of each group), the etch rate may be lower for a first area of the stratum 204 under a first section of the mask 202 (e.g., 234) than for a second are of the stratum 204 under a second section of the mask 202 (e.g., 232). Thus, as a result of the first stage of etching, the etch depth (H1) in the first area may be less than the depth (H2) in the second area.

The ratio (P+x:E or P:E-y or P+x:E-y) of the gases for the second stage can be chosen so that, in view of the different etch characteristics of the various sections of the partially-etched stratum 204, the trenches 210 are etched down to the surface of the substrate 208, as shown, for example, in FIG. 6C. In particular, the etching during the second stage allows removal of the stratum material 204 to expose the surface of the substrate 208 while avoiding undercutting the smaller meta-atoms (i.e., the group of meta-atoms having the lower density). Etching during the second stage can result in at least some of the meta-atoms 216 having outwardly sloping sidewalls 220 as described above.

Next, the mask 202 can be removed. As indicated by FIG. 6D, the resulting structure is an MOE that includes meta-atoms 216, at least some of which have sidewalls that are substantially vertical along the upper section (at 218) of the meta-atoms, and that slope outwardly along the lower section (at 220) of the meta-atom (i.e., the section of the meta-atom closer to the surface of the substrate that supports the meta-atoms).

As a particular example, a plasma etch may use a mixed gas of C₄F₈ as the passivation gas, and SF₆ as the etchant gas may be used to etch a stratum 204 composed of amorphous silicon. During the first stage, a ratio of 50:30 may be used for the amounts of passivation gas and etchant gas, whereas during the second stage, the ratio can be changed, for example, to 50:18. Other ratios may be appropriate for one or both stages. More generally, for the second stage, depending on the implementation, the change in ratio of the gases may be obtained by increasing the amount of the passivation gas, reducing the amount of the etchant gas, or both. Other gases may be used in some implementations for either one or both of the passivation gas and the etchant gas. For example, in some implementations, O₂ may be used as the passivation gas.

In some implementations, there may be no passivation gas or no etchant gas in either the first stage or the second stage of the etch process. That is, one stage may include only passivation gas (but no etchant gas) and the other stage may include only etchant gas (but no passivation gas).

In some implementations, instead of, or in addition to, increasing the amount of passivation gas in the second stage and/or reducing the amount of the etchant gas in the second stage of the plasma etch, the plasma power or the bias toward the substrate is reduced in the second stage. That is, the plasma power or the bias toward the substrate during the second stage of the plasma etch can be made less than the value during the first stage of the plasma etch. Other factors that may impact formation of the meta-atoms include the temperature of the substrate, the gas flow into the chamber and the pressure in the chamber. In addition, the overall shape of the meta-atoms, their size and the gap between adjacent meta-atoms may impact the extent of the outward slope of the meta-atom sidewalls.

In some implementations, as indicated by FIG. 7, instead of using a plasma etch having two stages, in which the amount of passivation gas in the second stage is increased and/or the amount of the etchant gas in the second stage is reduced relative to the first stage, the etch process includes a first stage (702) employing a plasma etch and a second stage (704) employing an isotropic etch. That is, the second stage can use, for example, a wet etchant that has a substantially uniform etch rate in all directions and that can provide a slope-controlled etch. In some cases, isotropic etching may tend to result in the sidewalls being outwardly curved (e.g., concave) rather than slanted.

While this specification contains many specifics, these should not be construed as limitations on the scope of the disclosure or of what may be claimed, but rather as descriptions of features specific to particular implementations. Certain features that are described in this specification in the context of separate implementations may also be combined. Conversely, various features that are described in the context of a single implementation may also be implemented in multiple implementations separately or in any suitable sub-combination. Various modifications can be made to the foregoing examples. Accordingly, other implementations also are within the scope of the claims.

1. An apparatus comprising:
a substrate supporting a plurality of meta-atoms each of which has at least one respective outer sidewall,
wherein an upper portion of the at least one sidewall of each of the meta-atoms is perpendicular to a surface of the substrate supporting the meta-atoms, and wherein a lower portion of the at least one sidewall of each of the meta-atoms slopes outwardly, the lower portion being adjacent an interface between the meta-atom and the surface of the substrate.

2. The apparatus of claim 1 wherein the lower portion of the at least one sidewall of each of the meta-atoms slants outwardly.

3. The apparatus of claim 1 wherein the lower portion of the at least one sidewall of each of the meta-atoms curves outwardly.

4. The apparatus of claim 1 wherein the lower portion of the at least one sidewall of each of the meta-atoms is concave-shaped.

5. The apparatus of claim 1 wherein a diameter of each respective one of the meta-atoms at the lower portion is greater than a diameter of the meta-atom at the upper portion of the meta-atom.

6. The apparatus of claim 1 wherein the lower portion of the at least one sidewall of each one of the meta-atoms extends less than fifty percent of the height of the meta-atom.

7. The apparatus of claim 6 wherein the lower portion of the at least one sidewall of each one of the meta-atoms extends no more than five percent of the height of the meta-atom.

8. The apparatus of claim 1, wherein the plurality of meta-atoms includes a first grouping of meta-atoms whose respective upper portions have a first diameter and a second grouping of meta-atoms whose respective upper portions have a second diameter that differs from the first diameter.

9. The apparatus of claim 1, wherein the plurality of meta-atoms includes a first grouping of meta-atoms arranged in a first density and a second grouping of meta-atoms arranged in a second density that differs from the first density.

10. The apparatus of claim 1, wherein:
the substrate is composed of glass or fused silica, and
the meta-atoms are composed of silicon, titanium oxide, zinc oxide, aluminum zinc oxide, or a niobium oxide.

11. A method comprising:
providing a structure that includes a layer of a stratum material on a substrate, the structure further including a mask on the stratum material, the mask defining areas of the stratum material where meta-atoms are to be formed, each of the respective meta-atoms having at least one sidewall; and
performing an etch process that includes:
a first etch stage that removes portions of the stratum material such that trenches are etched into the stratum material to form an upper section of the at least one sidewall of each of the meta-atoms, the upper section being perpendicular to a surface of the substrate; and
a second etch stage that removes further portions of the stratum material to form a lower portion of the at least one sidewall of each of the meta-atoms, the lower portion being adjacent an interface between the meta-atom and the surface of the substrate and sloping outwardly.

12. The method of claim 11 wherein each of the first and second etch stages is part of a plasma etch process.

13. The method of claim 11 wherein the first etch stage includes a plasma etch having an average flow of a passivation gas and an average flow of an etchant gas, and wherein the second etch stage includes a plasma etch in which at least one of an average flow of the passivation gas or an average flow of the etchant gas differs from the first etch stage.

14. The method of claim 13 wherein, in the second etch stage, the average flow of the passivation gas is greater than the average flow of the passivation gas during the first etch stage.

15. The method of claim 13 wherein, in the second etch stage, the average flow of the etchant gas is less than the average flow of the etchant gas during the first etch stage.

16. The method of claim 12, wherein at least one of a plasma power or a bias toward the substrate during the second etch stage is less than during the first etch stage.

17. The method of claim 11 wherein the first etch stage includes a plasma etch and the second stage includes an isotropic etch.

18. The method of claim 11, wherein the meta-atoms include a first grouping of meta-atoms whose respective upper portions have a first diameter and a second grouping of meta-atoms whose respective upper portions have a second diameter that differs from the first diameter.

19. The method of claim 11, wherein the meta-atoms include a first grouping of meta-atoms arranged in a first density and a second grouping of meta-atoms arranged in a second density that differs from the first density.

20. The method of claim 11, wherein:
the substrate is composed of glass or fused silica, and
the meta-atoms are composed of silicon, titanium oxide, zinc oxide, aluminum zinc oxide, or a niobium oxide.

21. The method of claim 11, further including removing the mask.
